(19) United States
(12) Patent Application Publication
(10) Pub. No.: US 2018/0365606 A1
(43) Pub. Date: Dec. 20, 2018

(54) PRIME VALUE CHAIN PLATFORM

(71) Applicant: Accenture Global Solutions Limited, Dublin (IE)

(72) Inventors: Mark O. George, Dallas, TX (US); John Otis Edmonson, Brooklyn, NY (US); Derek S. Wilson, Frisco, TX (US)

(21) Appl. No.: 16/012,405

(22) Filed: Jun. 19, 2018

Related U.S. Application Data
(60) Provisional application No. 62/522,341, filed on Jun. 20, 2017.

(51) Int. Cl. G06Q 10/06; G06Q 10/10

(52) U.S. Cl. CPC G06Q 10/067; G06Q 10/103; G06Q 10/0633

(57) ABSTRACT

Implementations are directed to a Prime Value Chain (PVC) Analyzer that identifies critical value chains and causes of systemic issues that traverse functions, all related to strategic outcomes clients are looking to drive. Methods, systems, and computer-readable medium to perform operations comprising obtaining data from a plurality of differing enterprise data sources; formatting the data to generate an integrated model having a hierarchy of activity levels related to enterprise operations; defining a critical path across each activity level of the hierarchy of activity levels, the critical path linking a subset of the activities; identifying a change to the integrated model that adjusts a parameter of one of the activities linked by the critical path; and in response to the adjusted parameter, updating a value of one or more metrics of the enterprise operations that is related to the critical path.

### CROSS-REFERENCE TO RELATED APPLICATION

This application claims priority to U.S. Provisional Patent Application No. 62/522,341 filed on Jun. 20, 2017, entitled “Prime Value Chain Platform,” which is hereby incorporated by reference in its entirety.

### BACKGROUND

Most organizations, e.g., businesses or government entities, that are seeking to drive substantive improvement in their organizational outcomes—such as improved customer experience, accelerated product time to market, strategic cost reduction, etc.—without impacting productivity, mission effectiveness, and end-to-end outcomes of the organizations. However, most all organizations struggle to make those substantive improvements—that is, when trying to diagnose performance, the organizations do so in the way that the organization is organized, and not in the way that the organization operates.

For example, to improve any metric of the organization (e.g., productivity, end-to-end tangible outcomes, performance enhancement, etc.), the way organizations typically address this is by looking at operating modules, people, structures, business unit components, how many different processes—that is, problems that give single narrow slices in that affect outcomes. However, attributes such as systems, technologies, data, human capital, and human skills also affect outcomes—including performance.

Thus, to try to improve performance by only looking at one function or one process at a time, and try to optimize/improve that one function/process, fails to provide visibility into how those changes affect other downstream systems and/or capabilities. Further, there are additional challenges when trying to improve end-to-end outcomes—i.e., providing access to data and providing collaboration in an organization of the data. Historically, such access was provided on a single computing device; however, doing so provides hinders or prevents collaboration.

### SUMMARY

Implementations of the present disclosure are generally directed to a Prime Value Chain (PVC) platform that provides data ingestion, analysis, and a suite of tools to identify critical value chains and causes of systemic issues that traverse functions related to strategic outcomes of one or more processes. The PVC platform collects, organizes, and identifies qualitative, and quantitative opportunities to improve efficiency and effectiveness across complex business ecosystems. Other implementations include corresponding methods, systems, apparatus, and computer programs, configured to perform the actions of the methods, encoded on computer-readable storage devices.

Innovative aspects of the subject matter described in this specification may be embodied in methods that include the actions of obtaining data from a plurality of differing enterprise data sources; formatting the data to generate an integrated model having a hierarchy of activity levels related to enterprise operations; defining a critical path across each activity level of the hierarchy of activity levels, the critical path linking a subset of the activities; identifying a change to the integrated model that adjusts a parameter of one of the activities linked by the critical path; and in response to the adjusted parameter, updating a value of one or more metrics of the enterprise operations that is related to the critical path.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other embodiments may each optionally include one or more of the following features. For instance, the one or metrics include full-time equivalent metrics and operating expense metrics. Updating the value of the one or more metrics includes updating a value of full-time equivalent metrics and a value of operating expense metrics. Providing, for display, the integrated model as a world on a page (WoaP) landscape. In response to updating the value of the one or more metrics, performing a simulation of the integrated model with the updated values of the one or more metrics. Defining an additional critical path across each activity level of the hierarchy of activity levels, the additional critical path linking a differing subset of the activities; and identifying the change to the integrated model that adjusts an additional parameter of an activity linked by the additional critical path. Providing, for display, a visualization of the critical path and the additional critical path at substantially the same time.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example high-level architecture in accordance with implementations of the present disclosure.

FIGS. 2-21 depict example graphical user interfaces of a World on a Page (WoaP) landscape that can be generated by a PVC platform.

FIG. 22 depicts an example process for generating a WoaP landscape.

FIG. 23 depicts an example system for generating a WoaP landscape.

### DETAILED DESCRIPTION

This application is related to cloud-based management of enterprise ecosystems that provide visibility into impacts of changes and that simplify management of transformational efforts. More particularly, implementations of the present disclosure are directed to a Prime Value Chain (PVC) platform that can capture information from an enterprise ecosystem, including activities that in any way can impact experience—e.g., a client experience. In at least one implementation, the PVC platform of the present disclosure enables enterprises to efficiently, and effectively implement improvements across all processes along a critical path.

As introduced above, organizations seek to drive substantive improvement in their organizational outcomes without impacting productivity, mission effectiveness, end-to-end outcomes of the organizations, etc. However, most organizations struggle to make those substantive improvements. For example, to improve any metric of the organization (e.g., productivity, end-to-end tangible outcomes, performance enhancement, etc.), organizations typically look at operating modules, people, structures, business unit components, how many different processes—that is, problems that give single narrow slices that affect outcomes. However, attributes, such as systems, technologies, data, human capital, and human skills, also affect outcomes—including performance.

However, in looking at one function or one process at a time, and trying to optimize/improve that one function/process, there is no visibility into how those changes affect other downstream systems and/or capabilities. Further, there are additional challenges in management to improve end-to-end outcomes—i.e., providing access to data and providing collaboration in an organization of the data.

In view of the above context, implementations of the present disclosure provide a PVC platform that can capture an enterprise ecosystem, including every process, and underlying activities that can impact a critical path. That is, the PVC platform provides a holistic view of all variables of an enterprise, and all inputs of an enterprise that affect an end-to-end outcome regardless of the origin of those inputs, e.g., inputs from third-party providers. Further, the PVC platform combines all activities—e.g., full-time equivalent (FTE) metrics and operating expense (OpEx) metrics, into an integrated model.

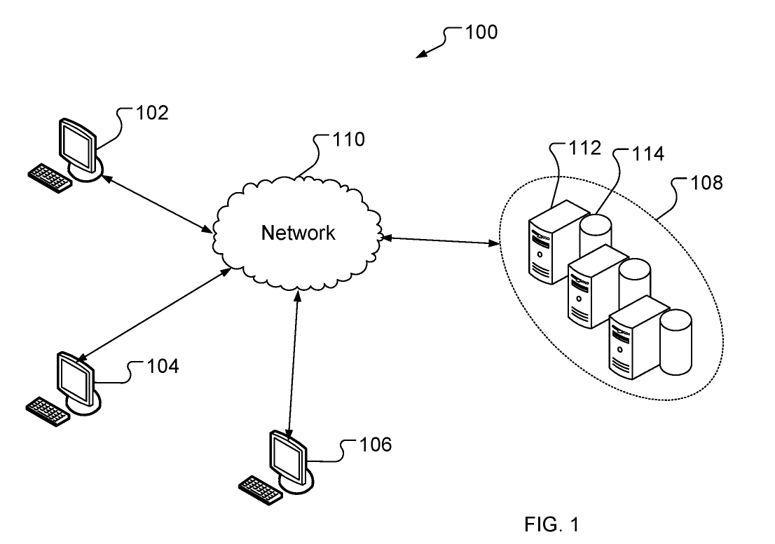

FIG. 1 depicts an example system 100 that can execute implementations of the present disclosure. The example system 100 includes computing devices 102, 104, 106, a back-end system 108, and a network 110. In some implementations, the network 110 includes a local area network (LAN), wide area network (WAN), the Internet, or a combination thereof, and connects web sites, devices (e.g., the computing device 102, 104, 106), and back-end systems (e.g., the back-end system 108). In some implementations, the network 110 can be accessed over a wired and/or a wireless communications link. For example, mobile computing devices, such as smartphones, can utilize a cellular network to access the network 110.

In the depicted example, the back-end system 108 includes at least one server system 112, and data store 114 (e.g., database). In some implementations, the at least one server system 112 hosts one or more computer-implemented services that users can interact with using computing devices. For example, the server system 112 can host a computer-implemented PVC platform in accordance with implementations of the present disclosure. In some implementations, back-end system 108 represents computer systems utilizing clustered computers and components to act as a single pool of seamless resources when accessed through a network. For example, such implementations may be used in data center, cloud computing, storage area network (SAN), and network attached storage (NAS) applications. In some implementations, back-end system 108 represents a virtual machine.

In some implementations, the computing devices 102, 104, 106 can each include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

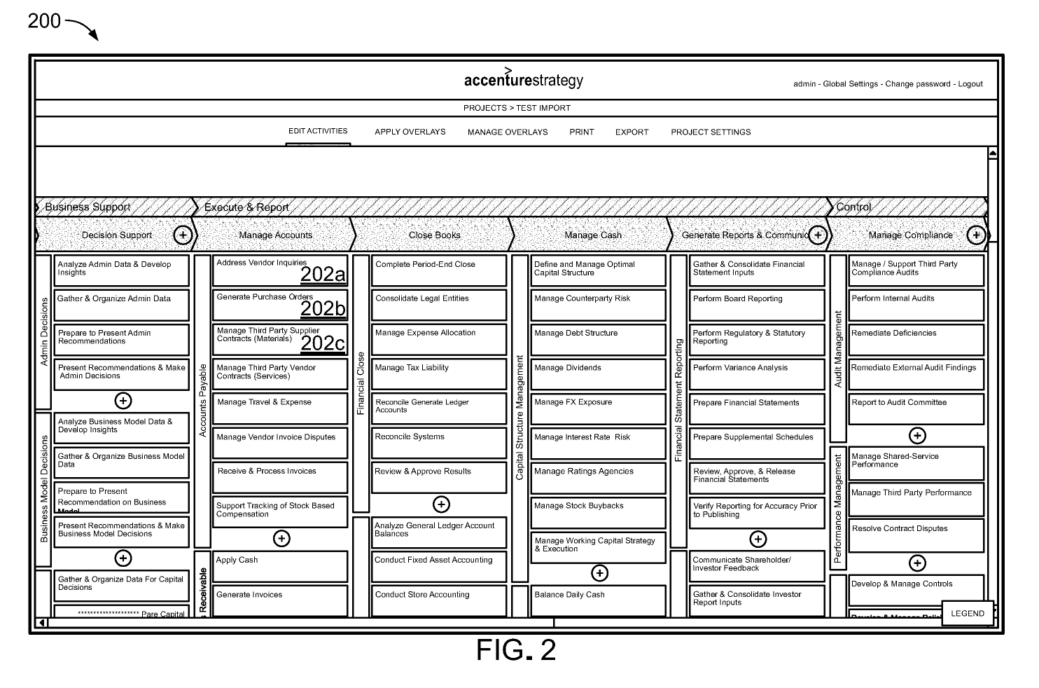

In accordance with implementations of the present disclosure, the computing devices 102, 104, 106 can interact with the back-end system 108 to interact with the PVC platform in accordance with implementations of the present disclosure. For example, and as described in further detail herein with reference to FIGS. 2-26, one or more of the computing devices 102, 104, 106 can interact with the back-end system 108 through respective graphical user interfaces (GUIs), which enable selection of data sources, topics, and sections of report generation, among other functions.

In further detail, the PVC platform of the present disclosure enables enterprises to move from functional optimization and silo management to holistic, end-to-end value chain management tied to enterprise outcomes. Further, the PVC platform enables enterprises to move from incremental, benefit-driven and disparate improvement projects to a prioritized portfolio of inter-related actions moving the “big needles” of performance. As described in further detail herein, the PVC platform enables improvement efforts to be driven top-down and bottom-up, to realize rapid, substantive and sustained improvement.

In general, the PVC platform enables identification of PVCs, provides process management, and execution of improvement efforts. Using complexity analytics, the PVC addresses issues that span a complex landscape, to establish value top-down from an enterprise customer's perspective, and identifies insights needed to enable strategic outcomes. Process management establishes end-to-end value stream governance, and process strategy to determine prioritization and targeted standardization, linking processes to strategy. In execution, the PVC platform provides an engine to manage and execute an inter-related portfolio of improvement opportunities addressed by continuous improvement, speed, agility, simplicity, and discipline.

In further detail, the PVC platform provides an analytical framework for enterprise outcomes and processes, establishes a value creation view, and identifies related activities and capabilities within the enterprise. The PVC platform links relationships, graphically depicts the critical path of enterprise transactions, and provides a dynamic view into the way work is performed within the enterprise, magnifying the activities that directly create the outcomes, and defining inter-related projects and actions to drive strategic objectives. In short, the PVC platform begins with enterprise outcomes, and top-down value creation, and depicts how work actually gets done through related activities regardless of functions, processes and their origins to provide an integrated view on how value is created helping move away from fragmented optimization.

In some examples, the PVC platform further provides hyperlink capability (e.g., to a sharepoint site) to all of the processes of an end-to-end business process such that one integrated blueprint of the process is provided. In some examples, the PVC platform can query FTE data and OpEx data, and align such back to individual activities. In some examples, the PVC platform facilitates generating models regarding automation of the activities of the WoaP landscape, including financial impact. In some examples, the PVC platform can provide functionality to create custom attributes and depict them visually across activities. In some examples, the PVC platform can provide chart creation—e.g., how many people provide value added work vs. non-value added work visually depicted as pie chart. In some examples, the PVC platform can provide information indicating the distribution of how many activities each technology system is used in. In some examples, the PVC platform provides collaboration of building quantitative components associated with activities, including multiple people adding activities, updating attributes in real time, and providing user access privileges to give access to client to the PVC platform. In some examples, the PVC platform provides the ability to do versioning overtime, e.g., over a particular WoaP landscape over time. That is, as new types of work are being, the PVC platform provides comparing of current state versus previous states.

The PVC platform ingests enterprise-related data from various systems. For example, the PVC platform can ingest data directly from enterprise data sources, and/or third-party data sources (e.g., suppliers that service the enterprise). Further, the PVC platform can ingest process models, or data describing process models, that are implemented by the enterprise to achieve its outcomes. In some examples, a process model can be provided as a data model that models activities and workflows performed by the enterprise. Data can be captured in interviews with enterprise agents (employees), and can be captured in various forms. For example, data recorded in disparate file types (e.g., MS Word, Excel) can be ingested.

The PVC platform, in an example implementation, provides a landscape view, e.g., a World on a Page (WoaP) landscape, based on the ingested enterprise data. FIG. 2 illustrates a GUI 200 of an example WoaP landscape that can be generated by the PVC platform. In general, the WoaP landscape depicts multiple levels of enterprise operations and varying degrees of granularity. For example, the WoaP landscape includes high-level processes, and for each, lower-level processes, and specific activities. In the example of FIG. 2, high-level processes include Business Support, Execute & Report, and Control (PVC Level 1). Within Execute & Report, for example, activities include Manage Accounts, Close Books, Manage Cash, and Generate Reports & Communicate (PVC Level 2). Within Manage Accounts, for example, example activities include Accounts Receivable, and Credit & Collections (PVC Level 3).

The WoaP landscape drills down to specific, concrete activities (PVC Level 4). For simplicity of illustration, only three activities, 202a, 202b, 202c are referenced, and include Generate Invoices, Apply Cash, and Manage A/R, respectively, of the Accounts Receivable activity. To that end, data that is currently stored in databases can be imported into the PVC platform. That is, notes can be obtained at an activity level within the PVC platform—including data related to description, attributes, points of contact, links, and feedback. The PVC platform further provides an activity feed that logs changes made and feedback provided—e.g., which contacts provided which activity within the PVC platform.

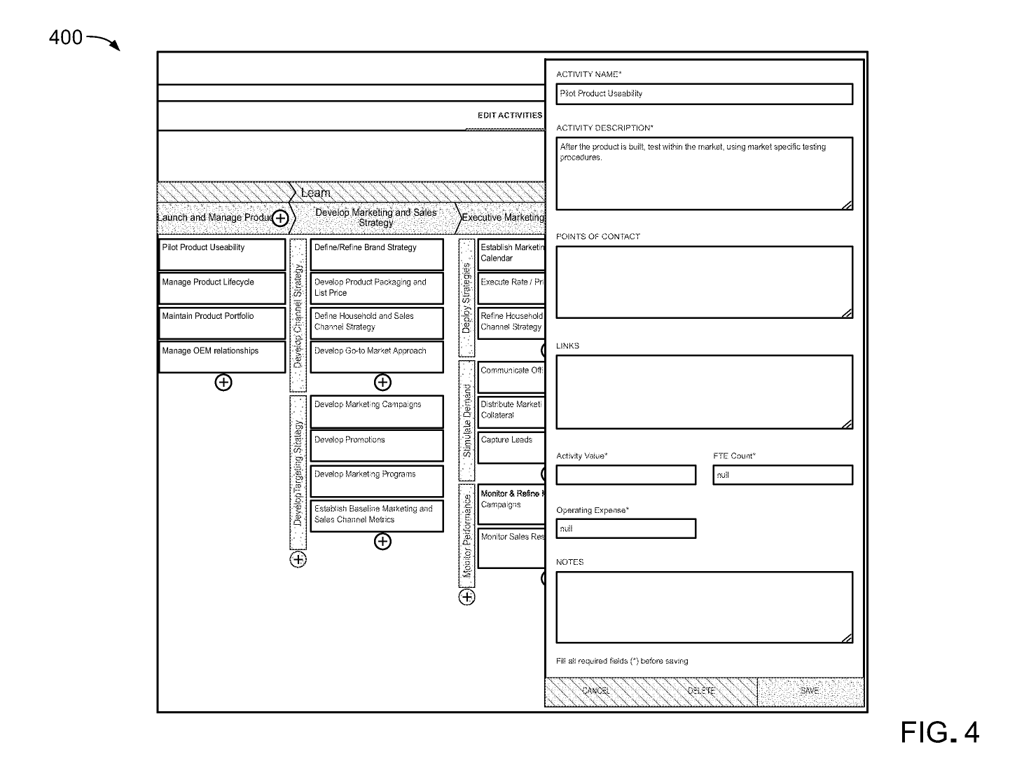

In general, the WoaP landscape includes activities based on all of the work associated with the WoaP landscape. That is, the PVC platform facilitates multiple users to add activities, description to activities, activity grouping, drag and drop around activity map, etc., that is auto formatted to the WoaP structure (described in further detail herein with reference to FIGS. 4-7). The PVC platform further allows importing/exporting of contents of a project into other databases (e.g., Microsoft Excel, Microsoft PowerPoint), manipulation of such data in the other databases, and importation back into the PVC platform.

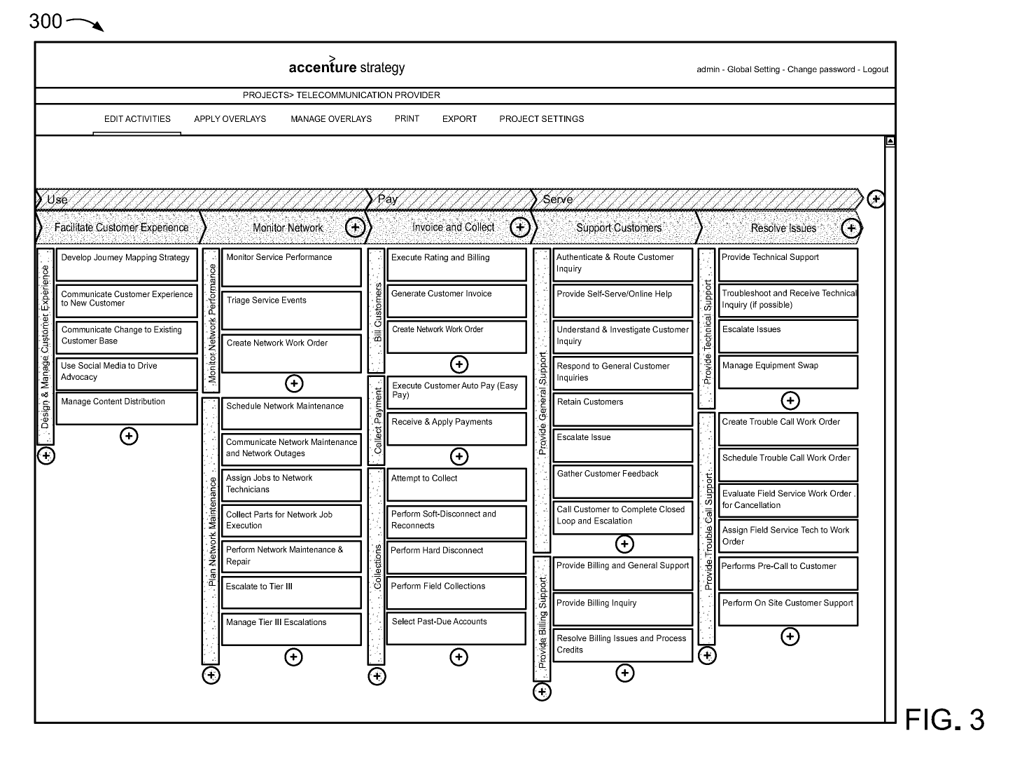

FIGS. 3 and 4 respectively illustrates GUIs 300, 400 of the WoaP depicting adding, changing, and deleting of activities at various levels. Specifically, under the “edit activities” menu, the PVC platform provides the ability to create new activities (at multiple levels); changing the activity name or deleting the activity of existing activities, and editing activity attributes of existing activities. For example, a user can click on an add activity icon (e.g., “+” icon) of a respective level to add an activity to that level. In the depicted examples, in response to the user clicking on an add activity icon of FIG. 3, the GUI 400 of FIG. 4 is displayed enabling the user to add an activity and define attributes for the activity (e.g., level 4 attributes: activity name, activity description, activity value category, FTE count, operating expense, and critical path identifier). In some examples, drag-and-drop functionality is provided to move activities (e.g., level 4) across columns.

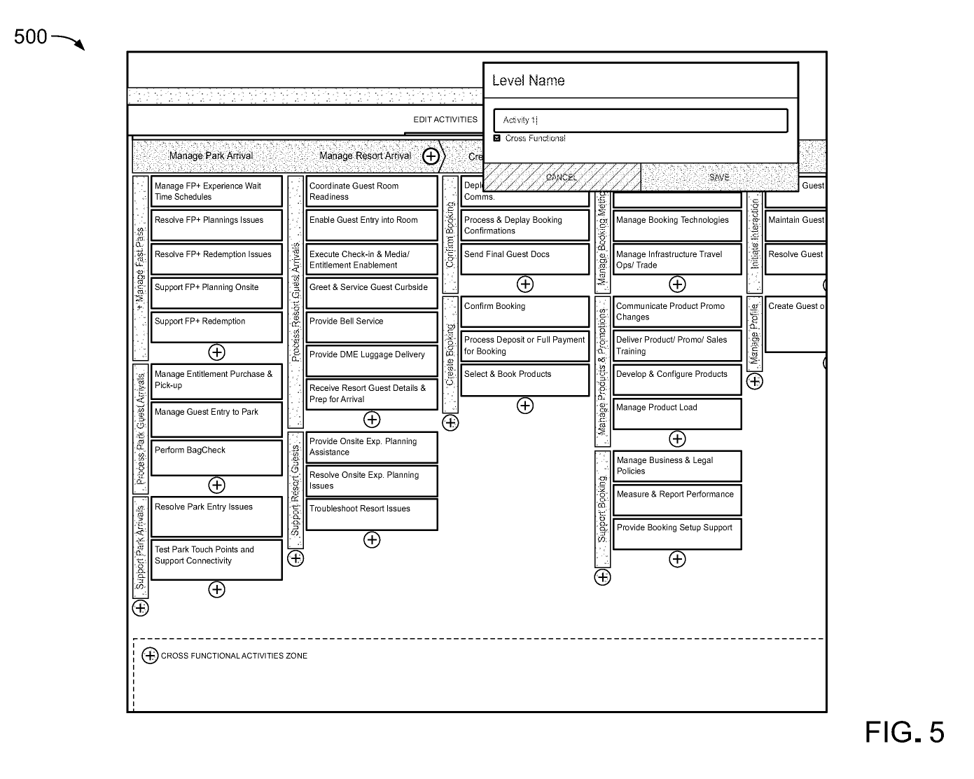

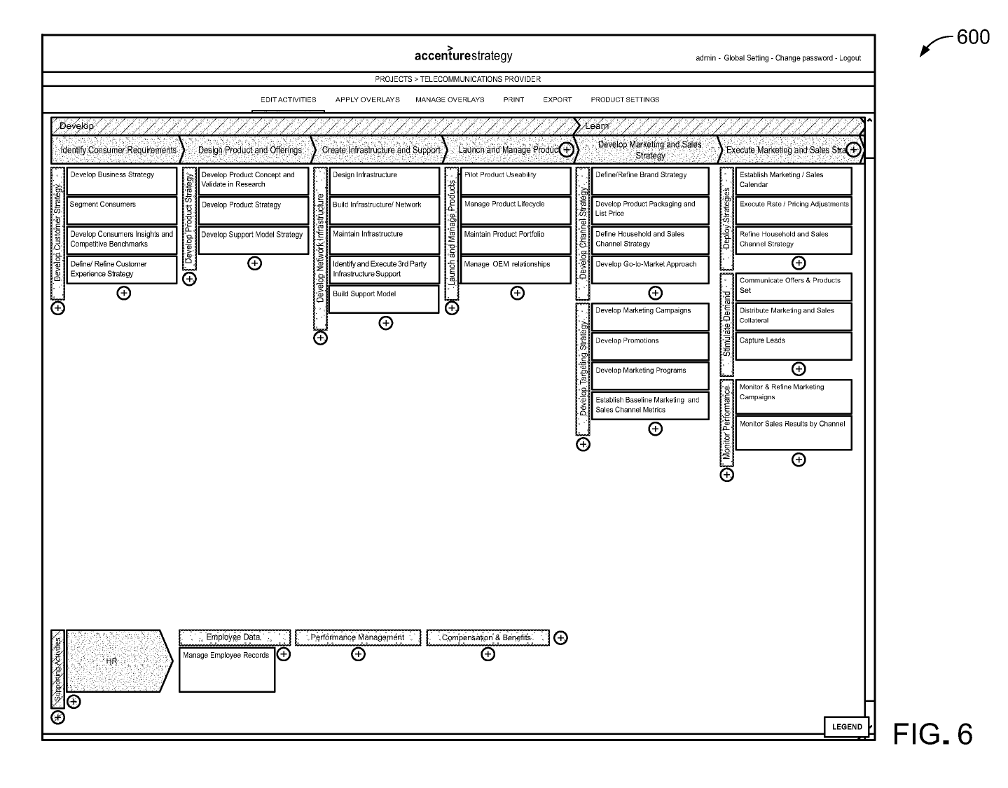

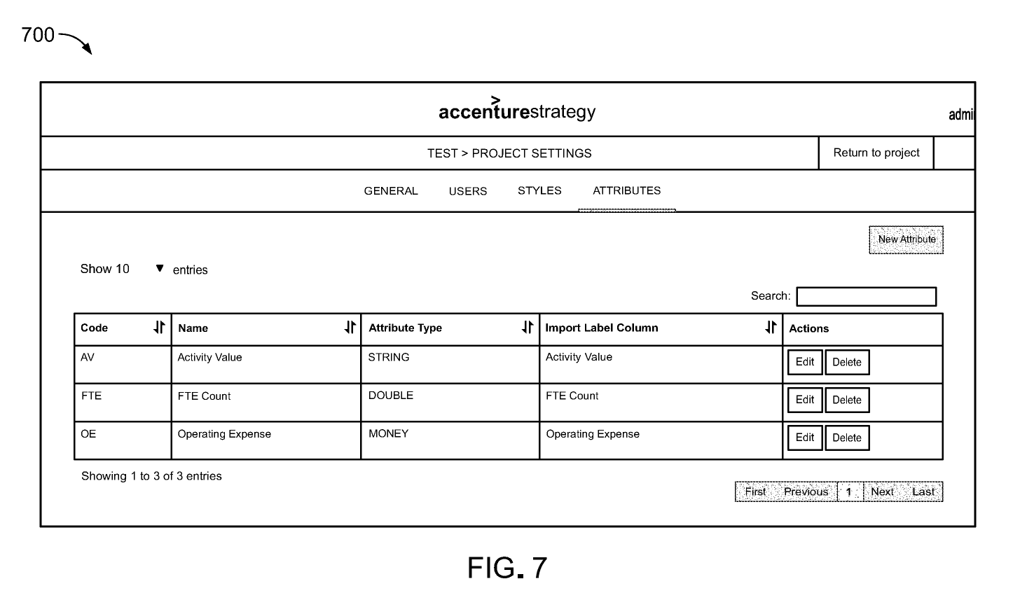

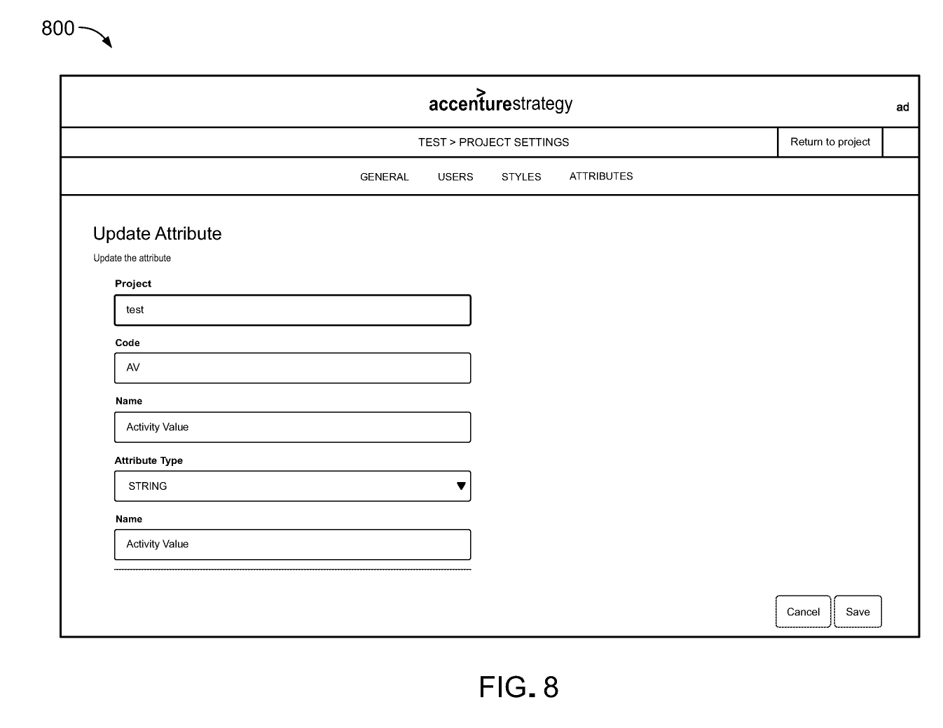

FIGS. 5 and 6 respectively illustrate GUIs 500, 600 of cross-functional activities. Specifically, the GUIs 500, 600 depicts the ability to create cross-functional activities (activities along the bottom of the WoaP that span columns of the WoaP). FIGS. 7 and 8 respectively illustrate GUIs 700 and 800 of activity attributes. Specifically, the GUI 700 depicts the ability to define custom attributes for activities, from the “Project Settings” menu option, including the ability to specify the type of attribute (e.g., pick list, open text, numeric, etc.).

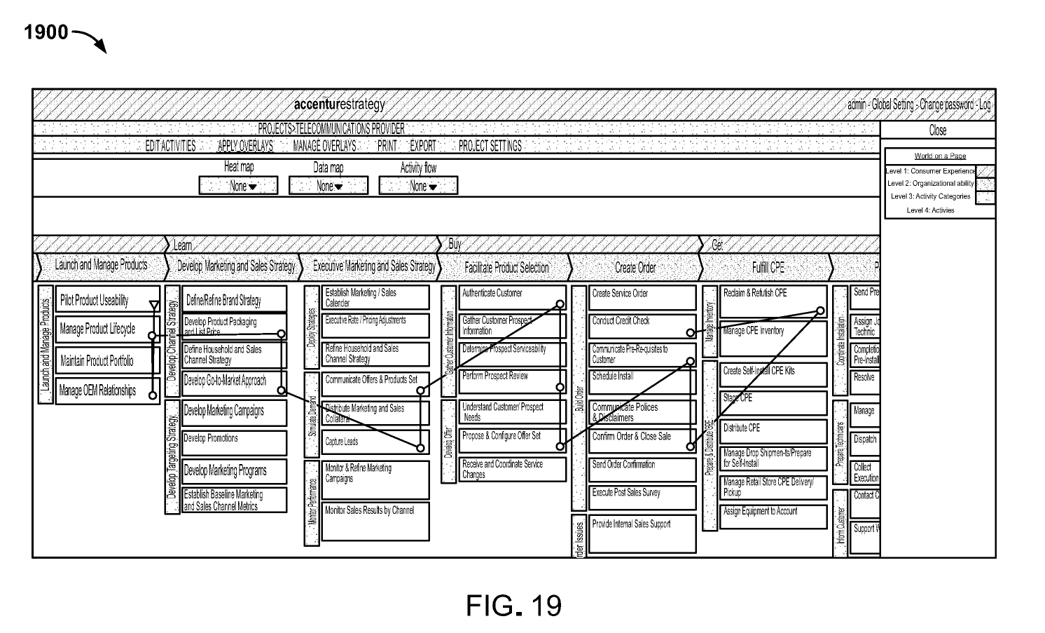

In short, the PVC platforms allows the ability to connect disparate function and processes in an end-to-end enterprise process, e.g., inventory of all capabilities, systems, data, and processes that are on available to the PVC for an end-to-end outcome. In an example, the PVC platform obtains a set of data (e.g., from another data source—a relational database), and formats the data into a plurality of activities, e.g., the activities 202a, 202b, 202c of the WoaP landscape, as shown in FIG. 2. The PVC platform enables a critical path to be defined across activities and all levels of the WoaP landscape. In some examples, the critical path is provided as a linking of activities, and represents how value traverses the enterprise to deliver a strategic outcome. The PVC platform can determine a critical path of a subset of the plurality of activities (as depicted in FIG. 19). In some examples, the critical path is selected, or edited by a user. In some examples, the critical path is determined automatically, e.g., based one or more factors (pre-selected by the user, or other). The critical path can have metrics associated therewith, such as FTE metrics and/or OpEx metrics. The PVC platform can adjust parameters associated with the activities of the critical path, such as adjusting the staffing or resources associated with the activities. The PVC platform, in response to the adjusted parameters, updating values of the metrics—e.g., the FTE metrics and/or OpEx metrics.

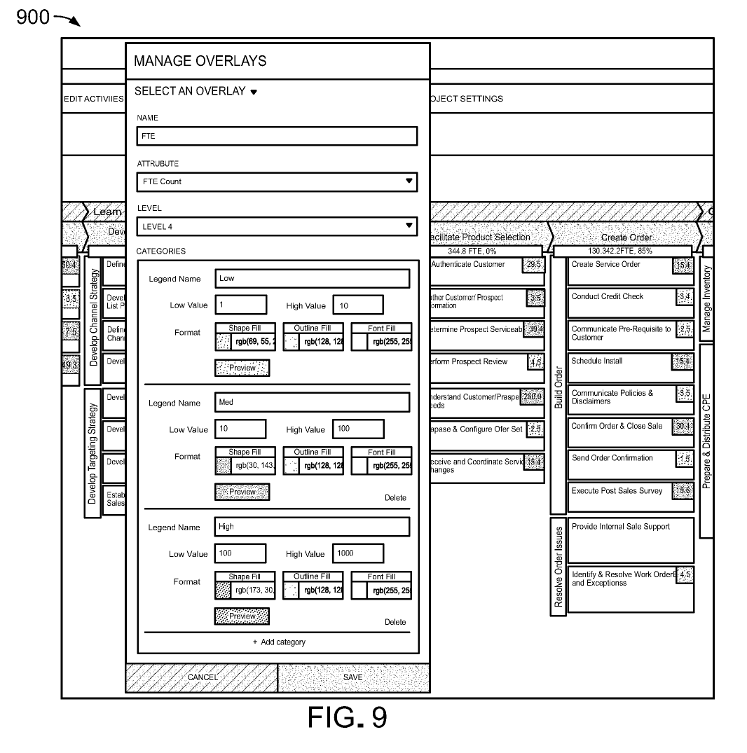

The PVC platform provides one or more lenses to be applied to a WoaP landscape based on respective overlays. Example lenses can include outcome creation, outcome impedance, customer impact, OpEx consumption, FTE consumption, and cycle time injection. Example overlays are described in further detail herein with reference to FIGS. 9-21. The example overlays are provided in multiple categories, which can include heat map, data map, and activity flow. Example heat maps can include a labor heat map, a FTE heat map, an OpEx heat map, and an activity value heat map. Example data maps can include a FTE data map, and an OpEx data map. Example activity flows include critical path, and user-specified paths. In some examples, new overlays can be added to each of the heat map, data map, and activity flow categories. For example, and as described herein, an overlay management interface can be provided which enables the user to add, edit, and/or remove overlays within each category. Further, overlays can be applied individually, or in combination.

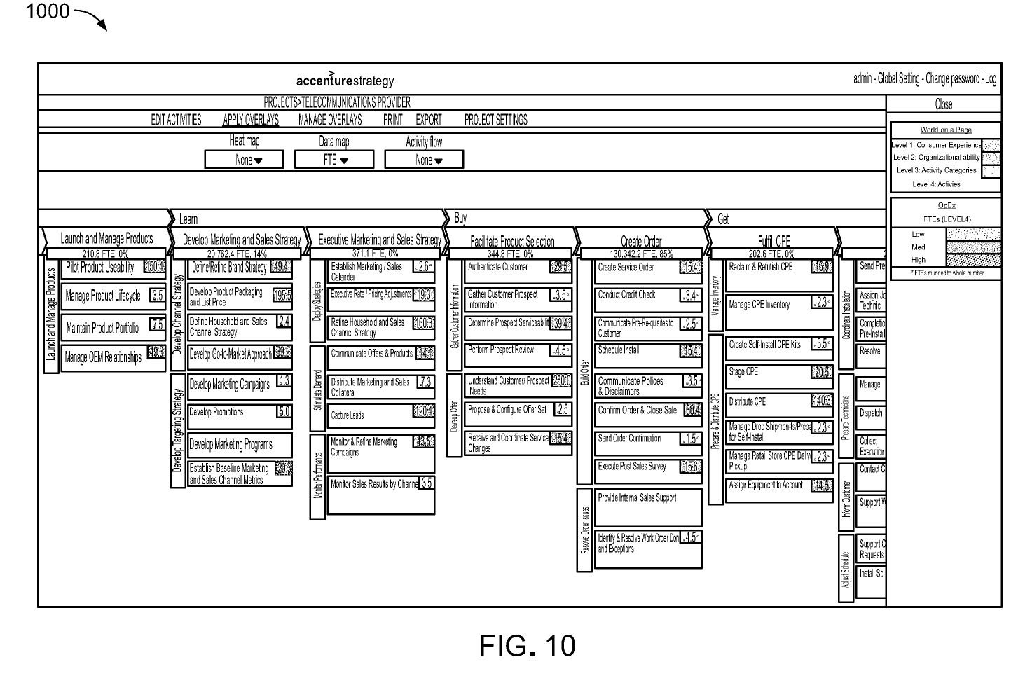

FIGS. 9 and 10 respectively illustrate a GUIs 900, 1000 depicting an overlay management interface for a FTE data map. Specifically, the GUI 900 enables the user to manage, in the depicted example, a FTE overlay, defining various values. The GUI 1000 depicts the FTE overlay as applied to a WoaP landscape. FTE counts are provided as decisional values in boxes on top of WoaP activities (using the values stored under the FTE attribute). The number of FTE groups, and the range of values within each group can be specified (e.g., using the GUI 900 of FIG. 9). Each group can also be customized (e.g., the fill, outline, and font color of each group). A legend is provided and can display all of the groups that have been defined, including the formatting and value range for each, as shown in the GUI 1000.

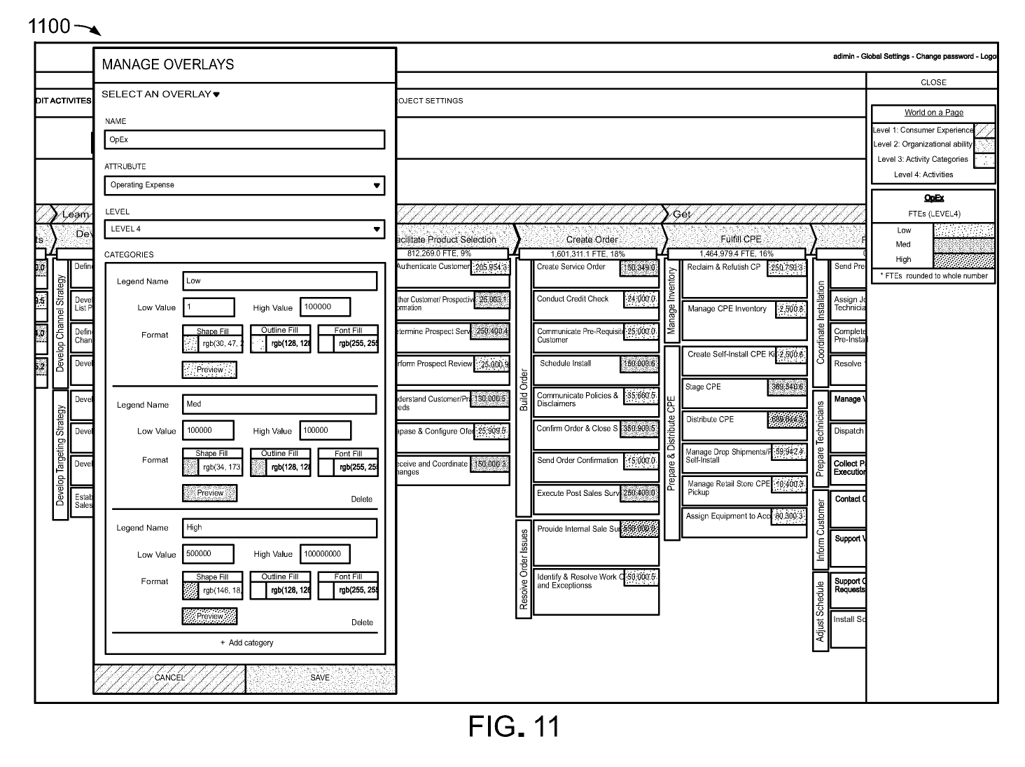

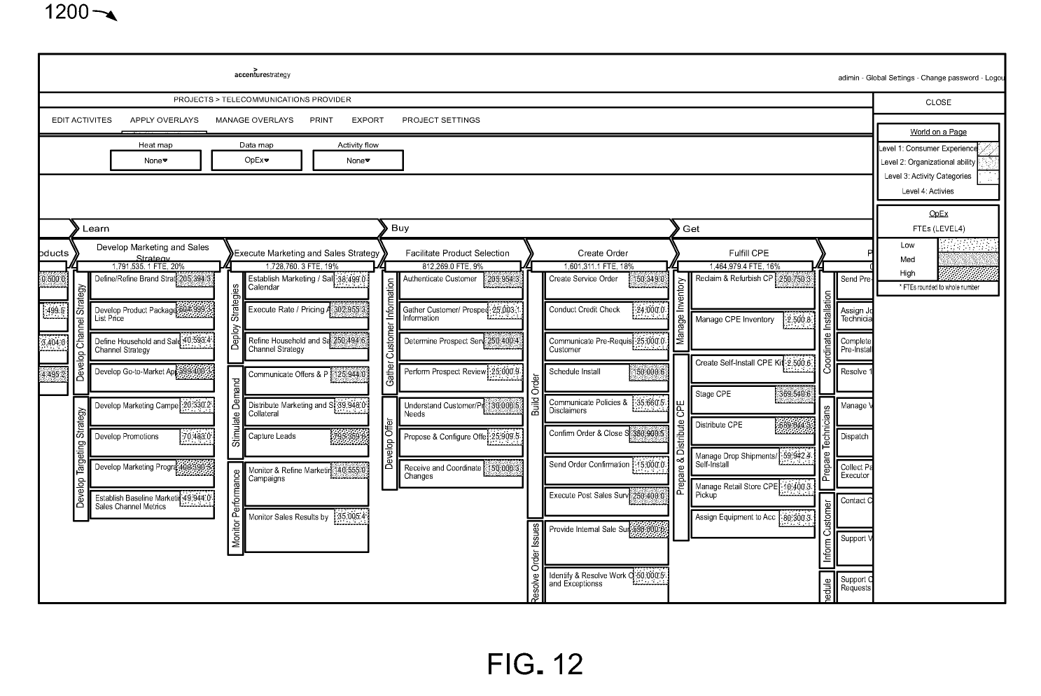

FIGS. 11 and 12 respectively illustrate GUIs 1100, 1200 of the WoaP depicting an OpEx data map. Specifically, the GUI 1100 enables the user to manage, in the depicted example, an OpEx overlay, defining various values. The GUI 1200 depicts OpEx as decisional values in boxes on top of WoaP activities (using the values stored under the OpEx attribute). The number of OpEx groups, and the range of values within each group can be specified. Each group can also be customized (e.g., the fill, outline, and font color of each group). A legend is provided and can display all of the groups that have been defined, including the formatting and value range for each, as shown in the GUI 1200.

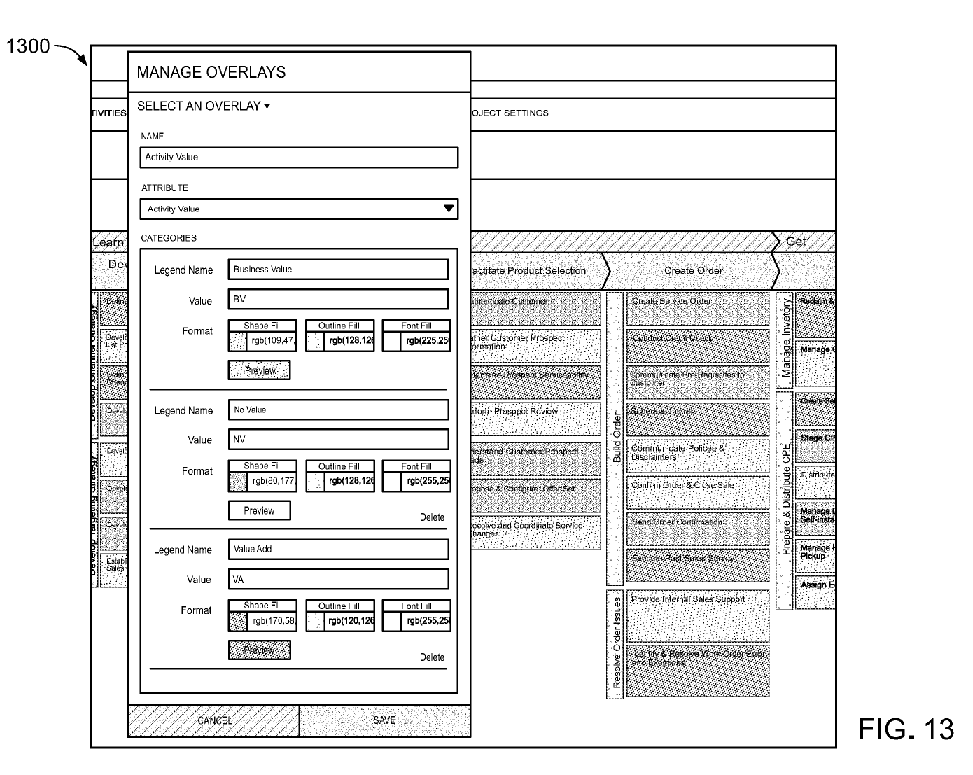

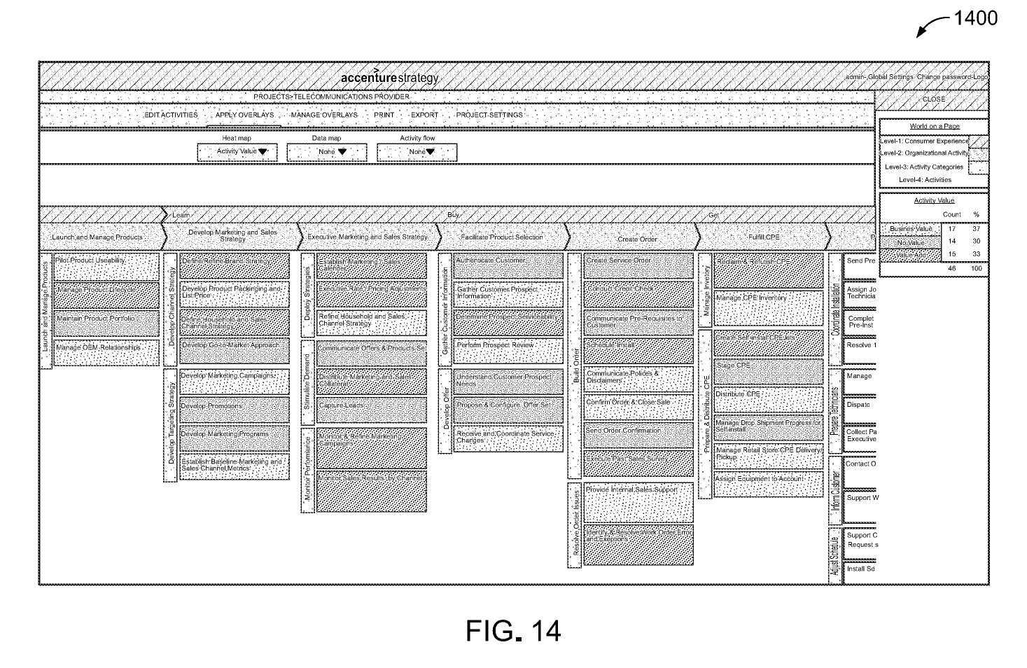

FIGS. 13 and 14 respectively illustrate GUIs 1300, 1400 of an activity value heat map. Specifically, the GUI 1300 enables the user to manage, in the depicted example, an activity value heat map overlay, defining various values. The GUI 1300 depicts activity values by shading each activity box a specific color based on its activity value attribute. The activity value category and the formatting of each category, including the fill, outline, and font color, can be specified. A legend is provided and can display all of the activity value categories that have been defined, including the formatting for each. Additionally, the legend can include metrics such as activity count by value category, and percent total by value category, as shown by FIG. 14.

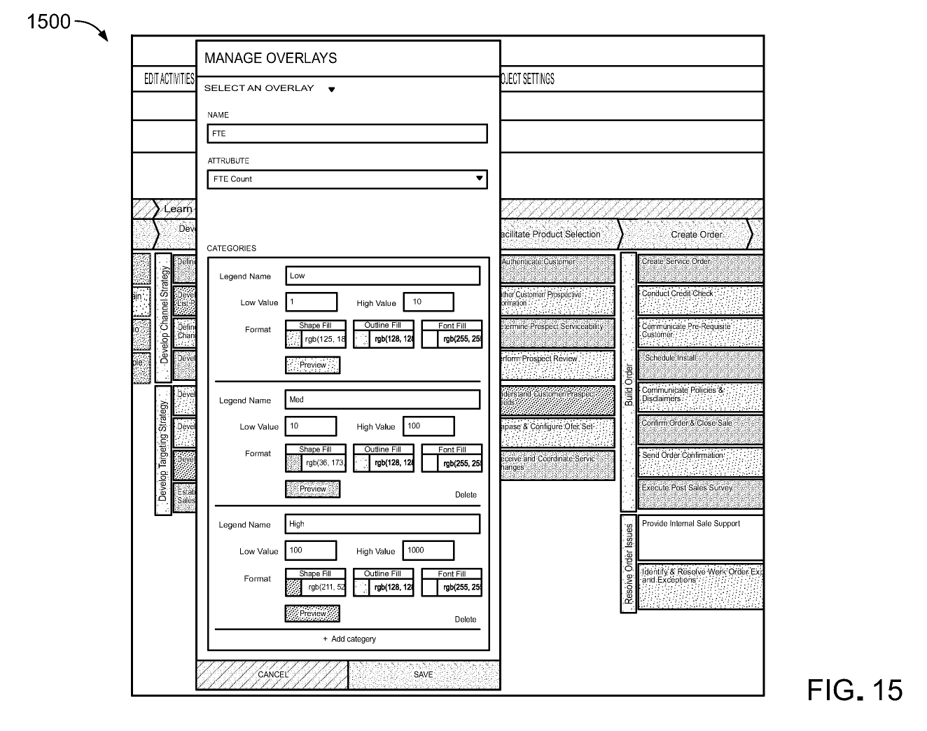

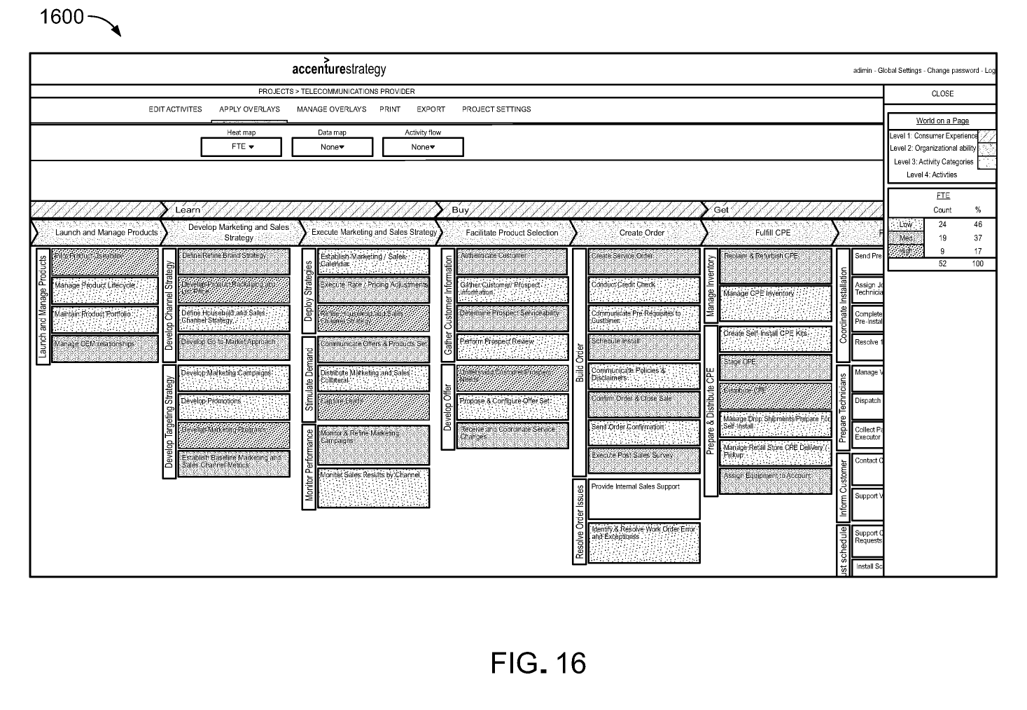

FIGS. 15 and 16 respectively illustrate GUIs 1500 and 1600 of a FTE count heat map. Specifically, the GUI 1500 enables the user to manage, in the depicted example, a FTE count heat map overlay, defining various values. The GUI 1600 depicts FTE concentration by shading each activity box a specific color based on its FTE attribute value. The number of groupings, the range of each group, and the formatting of each group, including the fill, outline, and font color can be specified. A legend is provided and can display all of the groups that have been defined, including the formatting and value range for each, as shown by FIG. 16.

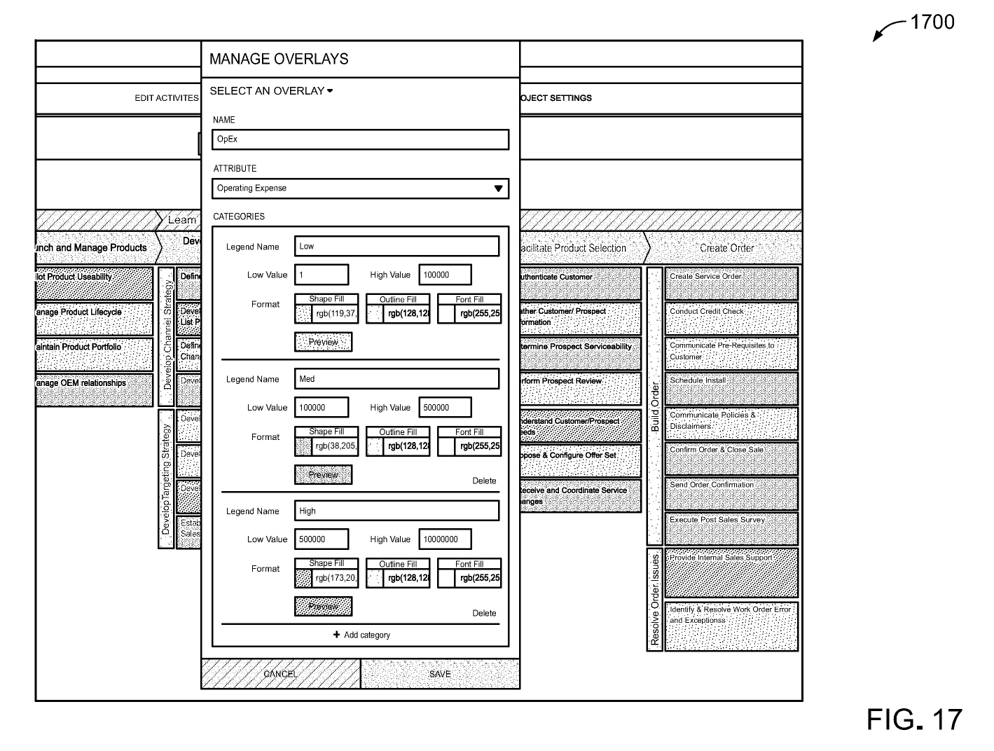

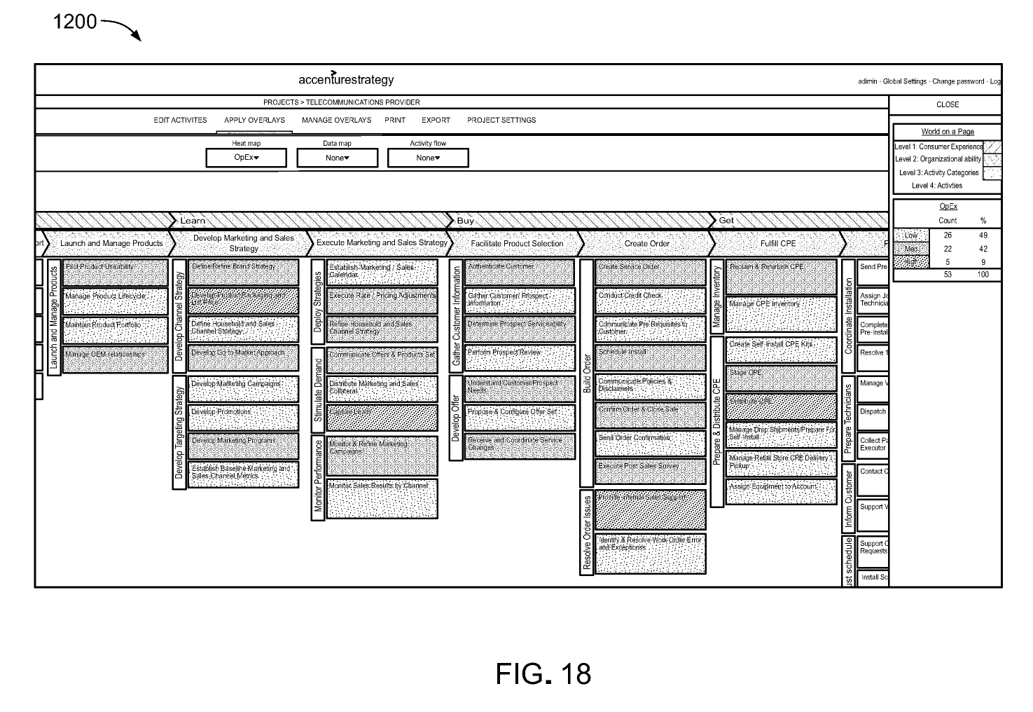

FIGS. 17 and 18 respectively illustrate GUIs 1700, 1800 of an OpEx heat map. Specifically, the GUI 1700 enables the user to manage, in the depicted example, an OpEx heat map overlay, defining various values. The GUI 1800 depicts OpEx concentrations by shading each activity box a specific color based on its OpEx attribute value. The number of groupings, the range of each group, and the formatting of each group, including the fill, outline, and font color can be specified. A legend is provided and can display all of the groups that have been defined, including the formatting and value range for each, as shown by FIG. 18.

FIG. 19 illustrates a GUI 1900 of the WoaP landscape (e.g., of FIG. 2) with a critical path overlay depicting a critical path that is dynamically selected based on activities of the WoaP. To that end, the critical path is selected such that when changes are made to the organization associated with the WoaP (e.g., adjusting of a specific parameter such as adjust staffing, or shift resources), the PVC platform determines the impact as it relates to other key metrics (e.g., how it changes total cost of a transaction flow, how it reduces capacity in executing a given activity, etc.). That is, the PVC platform provides simulation of different scenarios on organizational changes. The critical path, when selected, shows such metrics as a total cost of the activities of the critical path, human capital of the activities of the critical path, etc. In some examples, the WoaP landscape includes multiple critical paths that are visualized at substantially a same time. In the depicted example, each activity included in the critical path is depicted by a circle in the corner of the activity. The flow can be represented by lines connecting each of the circles. The fill and outline colors of the critical path can be specified. A legend is provided and can display the title and formatting of the critical path.

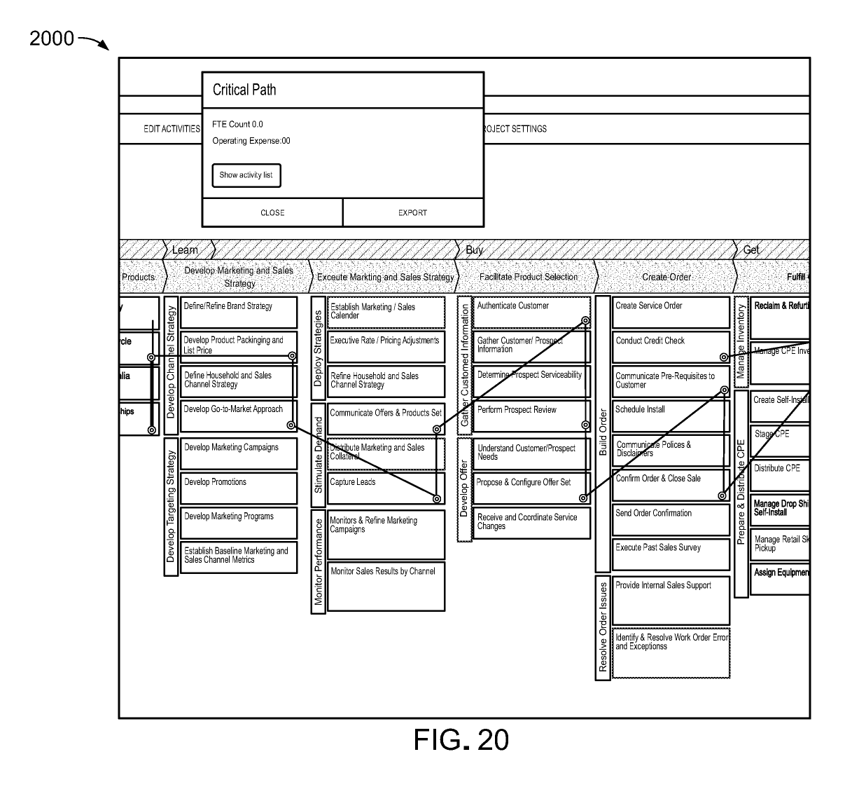

FIG. 20 illustrates a GUI 2000 of attributes of critical path activities. Specifically, the GUI 2000 enables selection of a critical path activity, and view a pop-up containing the attributes defined for that critical path activity. Within the pop-up, a “Show activity list” button is displayed that when selected, provides viewing of all of the activities along the critical path, including the attributes of each.

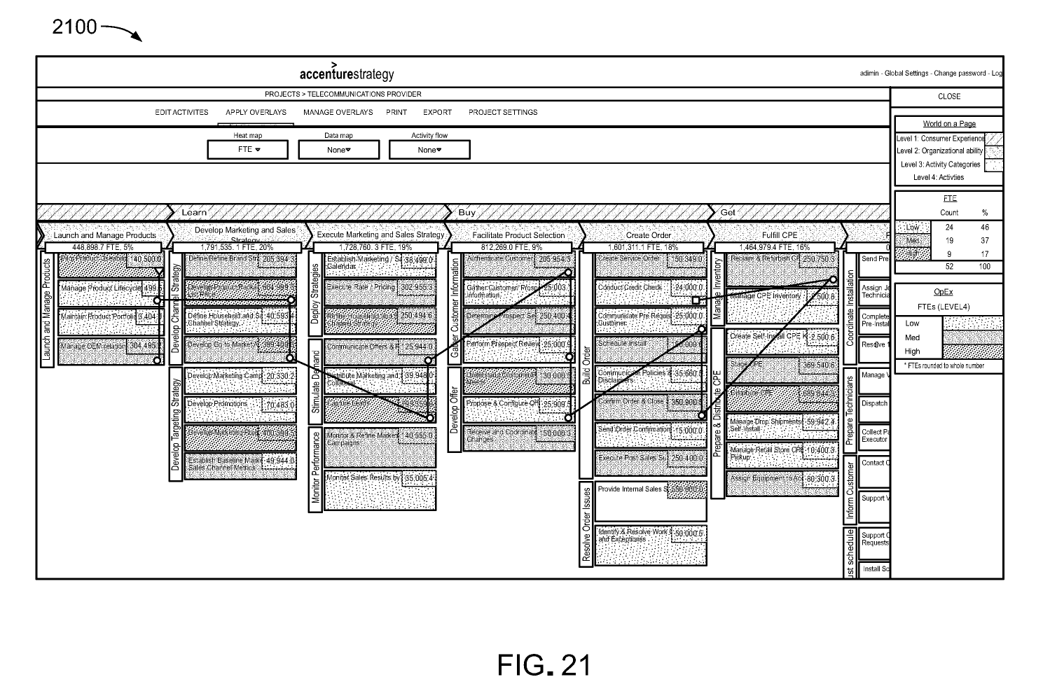

As noted above, implementations of the present disclosure enable multiple overlays to be concurrently applied. For example, a heat map overlay, a data map overlay, and an activity flow overlay can be applied individually, or in various combinations. FIG. 21 illustrates a GUI 2100 of combined overlays. Specifically, the GUI 2100 depicts the ability to combine multiple overlays in a single view of the WoaP landscape. In the illustrated example, a heat map overlay is provided, where different colors of the activities indicate different values associated with the activities (e.g., as selected by a user of the PVC platform). In some examples, the overlays are not limited to FTE, and can also include overlays depicting activities (e.g., how long to complete each individual activity), overlays depicting technology systems (e.g., how many systems are used in performing each activity), and other quantitative overlays.

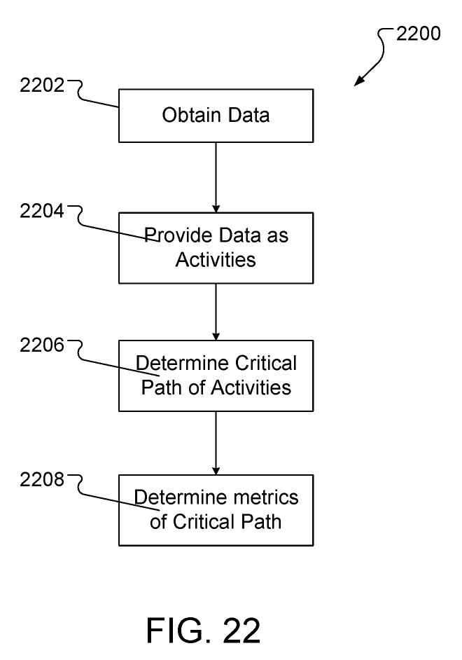

FIG. 22 depicts an example process 2200 for generating a WoaP landscape that can be executed in accordance with implementations of the present disclosure. In some implementations, the example process 2200 is provided using one or more computer-executable programs executed by one or more computing devices (e.g., the back-end system 108 of FIG. 1). Data from a data source is obtained (2202). The data is provided for display as a plurality of activities (2204). A critical path of a subset of the plurality of activities is determined (2206). One or more metrics associated with the critical path is determined (2208).

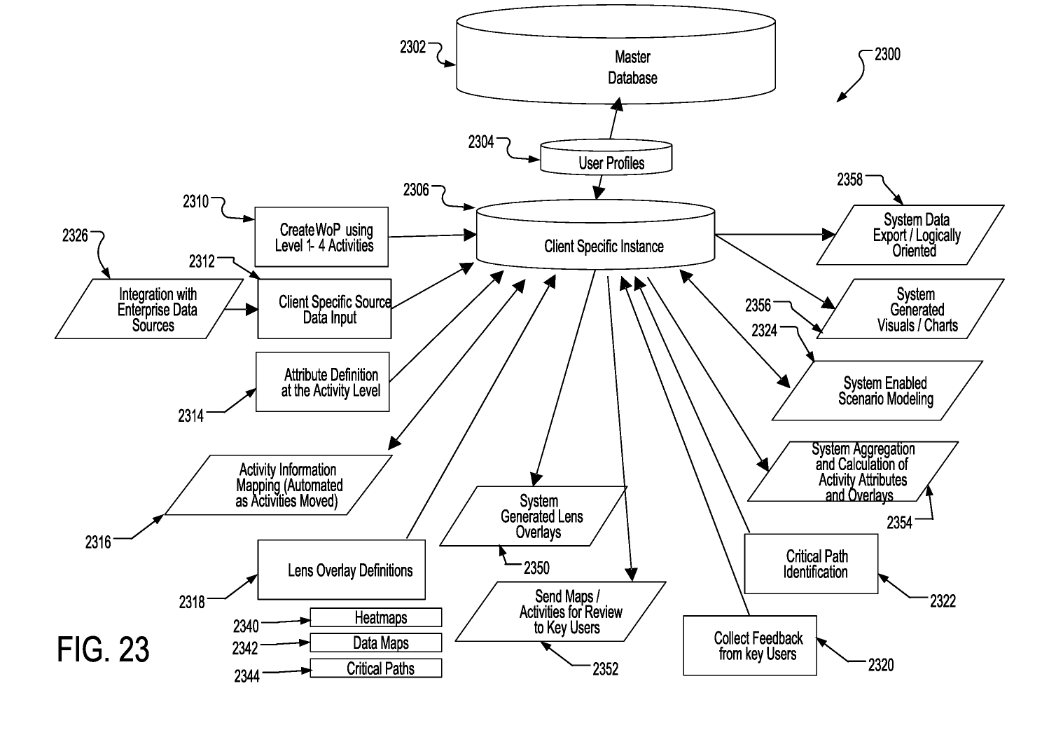

FIG. 23 depicts a system 2300 (e.g., PVC tool) for generating a WoaP landscape in accordance with implementations of the present disclosure. Specifically, from a master database 2302, user profiles 2304 can be accessed, and the PVC tool can create a client-specific instance 2306 (e.g., the WoaP landscape). The client-specific instance 2306 can be associated with many processes steps as described further above, including creation of the WoaP landscape 2310 (e.g. level 1, 2, 3, and 4 activities), client-specific source data input 2312, attribute definition 2314 (e.g., at the activity level), activity mapping information 2316 (e.g., automated as activities moved), lens overlay definition 2318, collection of feedback from key users 2320, critical path identification 2322, and system enabled scenario modeling 2324. Moreover, client-specific source data input 2312 can be associated with an integration with enterprise data sources 2326 process step. Moreover, lens overlay definition 2318 can be associated with heat maps 2340, data maps 2342, and critical paths 2344. Process steps 2310-2324 can be associated with process steps that provide input to (e.g., of data) to the client-specific instance 2306 in the formation of the WoaP landscape (e.g., by the PVC tool).

Furthermore, the client-specific instance 2306 can be associated with processes as described further above that include solutions in creation of the WoaP landscape. Specifically, the processes can include the activity information mapping 2316, system generated overlay 2350, send maps/activities for review to key users 2352, system aggregation and calculation of activity attributes and overlays 2354, system enabled scenario modeling 2324, system generated visuals/charts 2356, and system data export/logically orientated 2358. In some examples, the process steps 2310-2358 can occur in any order, including two or more of the processes steps occurring simultaneously. The client-specific instance 2306 is generated by the PVC tool by stepping through any portion of the process steps 2310-2358 in any order as desired (e.g., as determined by client-specific parameters). The process steps 2310-2358 can be performed by any systems of FIG. 1.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method, comprising:
obtaining data from a plurality of differing enterprise data sources;
formatting the data to generate an integrated model having a hierarchy of activity levels related to enterprise operations;
defining a critical path across each activity level of the hierarchy of activity levels, the critical path linking a subset of the activities;
identifying a change to the integrated model that adjusts a parameter of one of the activities linked by the critical path; and
in response to the adjusted parameter, updating a value of one or more metrics of the enterprise operations that is related to the critical path.

2. The computer-implemented method of claim 1, wherein the one or metrics include full-time equivalent metrics and operating expense metrics.

3. The computer-implemented method of claim 2, wherein updating the value of the one or more metrics includes updating a value of full-time equivalent metrics and a value of operating expense metrics.

4. The computer-implemented method of claim 1, further comprising providing, for display, the integrated model as a world on a page (WoaP) landscape.

5. The computer-implemented method of claim 1, further comprising, in response to updating the value of the one or more metrics, performing a simulation of the integrated model with the updated values of the one or more metrics.

6. The computer-implemented method of claim 1, further comprising:
defining an additional critical path across each activity level of the hierarchy of activity levels, the additional critical path linking a differing subset of the activities; and
identifying the change to the integrated model that adjusts an additional parameter of an activity linked by the additional critical path.

7. The computer-implemented method of claim 6, further comprising providing, for display, a visualization of the critical path and the additional critical path at substantially the same time.

8. A system, comprising:
one or more processors; and
a non-transitory computer-readable storage medium coupled to the one or more processors and storing programming instructions for execution by the one or more processors, the programming instructions instruct the one or more processors to:
obtaining data from a plurality of differing enterprise data sources;
formatting the data to generate an integrated model having a hierarchy of activity levels related to enterprise operations;
defining a critical path across each activity level of the hierarchy of activity levels, the critical path linking a subset of the activities;
identifying a change to the integrated model that adjusts a parameter of one of the activities linked by the critical path; and
in response to the adjusted parameter, updating a value of one or more metrics of the enterprise operations that is related to the critical path.

9. The system of claim 8, wherein the one or metrics include full-time equivalent metrics and operating expense metrics.

10. The system of claim 9, wherein updating the value of the one or more metrics includes updating a value of full-time equivalent metrics and a value of operating expense metrics.

11. The system of claim 8, the operations further comprising providing, for display, the integrated model as a world on a page (WoaP) landscape.

12. The system of claim 8, the operations further comprising, in response to updating the value of the one or more metrics, performing a simulation of the integrated model with the updated values of the one or more metrics.

13. The system of claim 8, the operations further comprising:
defining an additional critical path across each activity level of the hierarchy of activity levels, the additional critical path linking a differing subset of the activities; and
identifying the change to the integrated model that adjusts an additional parameter of an activity linked by the additional critical path.

14. The system of claim 13, the operations further comprising providing, for display, a visualization of the critical path and the additional critical path at substantially the same time.

15. A non-transitory computer readable medium storing instructions to cause one or more processors to perform operations comprising:
obtaining data from a plurality of differing enterprise data sources;
formatting the data to generate an integrated model having a hierarchy of activity levels related to enterprise operations;
defining a critical path across each activity level of the hierarchy of activity levels, the critical path linking a subset of the activities;
identifying a change to the integrated model that adjusts a parameter of one of the activities linked by the critical path; and
in response to the adjusted parameter, updating a value of one or more metrics of the enterprise operations that is related to the critical path.

16. The computer readable medium of claim 15, wherein the one or metrics include full-time equivalent metrics and operating expense metrics.

17. The computer readable medium of claim 16, wherein updating the value of the one or more metrics includes updating a value of full-time equivalent metrics and a value of operating expense metrics.

18. The computer readable medium of claim 15, the operations further comprising providing, for display, the integrated model as a world on a page (WoaP) landscape.

19. The computer readable medium of claim 15, the operations further comprising, in response to updating the value of the one or more metrics, performing a simulation of the integrated model with the updated values of the one or more metrics.

20. The computer readable medium of claim 15, the operations further comprising:
defining an additional critical path across each activity level of the hierarchy of activity levels, the additional critical path linking a differing subset of the activities; and
identifying the change to the integrated model that adjusts an additional parameter of an activity linked by the additional critical path.
